(19) United States
(12) Patent Application Publication
(10) Pub. No.: US 2016/0009501 A1
(43) Pub. Date: Jan. 14, 2016

(54) CLEANING APPARATUS AND CLEANING METHOD

(71) Applicant: AIKAWA IRON WORKS CO., LTD., Shizuoka-shi (JP)

(72) Inventor: Masaki AIKAWA, Shizuoka-shi (JP)

(21) Appl. No.: 14/680,668

(22) Filed: Apr. 7, 2015

(30) Foreign Application Priority Data
Jul. 14, 2014 (JP) 2014-144091

(51) Int. Cl. B65G 45/12; B65G 45/14

(52) U.S. Cl. CPC B65G 45/12; B65G 45/14

(57) ABSTRACT

A cleaning apparatus for a belt-shaped member for papermaking includes a rotary member situated adjacent to the belt-shaped member and having a plurality of rotary blades rotating in a direction opposite to a movement direction of the belt-shaped member. The rotary member is arranged such that the plurality of rotary blades contacts one side of the belt-shaped member in order, to scrape off foreign materials on the belt-shaped member.

### BACKGROUND OF THE INVENTION AND RELATED ART STATEMENT

The present invention relates to a cleaning apparatus and a cleaning method, and especially relates to the cleaning apparatus and the cleaning method which can powerfully scrape off foreign materials on a belt-shaped member.

Conventionally, on the belt-shaped member such as a canvas and the like used for a dryer part for a paper making machine, there are attached foreign materials such as a paper powder, a pitch, and the like, and the foreign materials are removed by a stationary blade (see Japanese Utility Model Publication No. H06-69297).

However, there is a problem that the removal by the aforementioned blade (the stationary blade) is not sufficient.

The present invention is made in view of the aforementioned problem, and an object of the present invention is to provide a cleaning apparatus and a cleaning method which can powerfully scrape off the foreign materials on the belt-shaped member.

Further objects and advantages of the invention will be apparent from the following description of the invention.

### SUMMARY OF THE INVENTION

A cleaning apparatus according to the first aspect of the invention is a cleaning apparatus for a belt-shaped member such as a canvas for papermaking, a felt, and the like, and there is provided a rotary member disposed outside the belt-shaped member, and rotating opposite to a movement direction of the belt-shaped member so as to scrape off foreign materials on the belt-shaped member by a rotary blade.

Also, as for the cleaning apparatus according to the second aspect, in the cleaning apparatus according to the first aspect, there is provided the stationary blade disposed outside the belt-shaped member, and provided in front of or behind the rotary blade, or in front of and behind the rotary blade relative to the movement direction of the belt-shaped member, and the foreign materials on the belt-shaped member are scraped off by the stationary blade.

Also, a cleaning method according to the third aspect is the cleaning method cleaning the foreign materials such as a pitch and the like on the belt-shaped member such as the canvas for papermaking, the felt, and the like, and the foreign materials on the belt-shaped member are scraped off by the rotary blade of the rotary member disposed outside the belt-shaped member and rotating opposite to the movement direction of the belt-shaped member.

Also, as for the cleaning method according to the fourth aspect, in the cleaning method according to the third aspect, there is provided the stationary blade disposed outside the belt-shaped member, and provided in front of or behind the rotary blade, or in front of and behind the rotary blade relative to the movement direction of the belt-shaped member, and the foreign materials on the belt-shaped member are scraped off by the stationary blade.

With respect to the cleaning apparatus according to the first aspect, there is provided the rotary member disposed outside the belt-shaped member, and rotating opposite to the movement direction of the belt-shaped member so as to scrape off the foreign materials on the belt-shaped member by the rotary blade, so that the foreign materials (the foreign materials are, for example, a paper powder, the pitch, and the like) on the belt-shaped member can be powerfully scraped off to the extent that the rotational direction of the rotary member rotates opposite to the movement direction of the belt-shaped member.

Also, with respect to the cleaning apparatus according to the second aspect, in addition to the effect of the invention according to the aforementioned first aspect, the foreign materials (the foreign materials are, for example, the paper powder, the pitch, and the like) on the belt-shaped member, which cannot be removed by the rotary blade of the rotary member, can be removed by the stationary blade disposed outside the belt-shaped member, and provided in front of or behind the rotary blade, or in front of and behind the rotary blade relative to the movement direction of the belt-shaped member.

Also, with respect to the cleaning method according to the third aspect, there is provided the rotary member disposed outside the belt-shaped member, and rotating opposite to the movement direction of the belt-shaped member so as to scrape off the foreign materials (the foreign materials are, for example, the paper powder, the pitch, and the like) on the belt-shaped member by the rotary blade, so that the foreign materials (the foreign materials are, for example, the paper powder, the pitch, and the like) on the belt-shaped member can be powerfully scraped off by that the rotational direction of the rotary member rotates opposite to the movement direction of the belt-shaped member.

Also, with respect to the cleaning method according to the fourth aspect, in addition to the effect of the invention according to the aforementioned first aspect, the foreign materials (the foreign materials are, for example, the paper powder, the pitch, and the like) on the belt-shaped member, which cannot be removed by the rotary blade of the rotary member, can be removed by the stationary blade disposed outside the belt-shaped member, and provided in front of or behind the rotary blade, or in front of and behind the rotary blade relative to the movement direction of the belt-shaped member.

### BRIEF DESCRIPTION OF THE DRAWINGS

FIG. 1 is a schematic side view of a cleaning apparatus of one embodiment of the present invention; and

FIG. 2 is a schematic partially enlarged side view wherein one portion in FIG. 1 is enlarged.

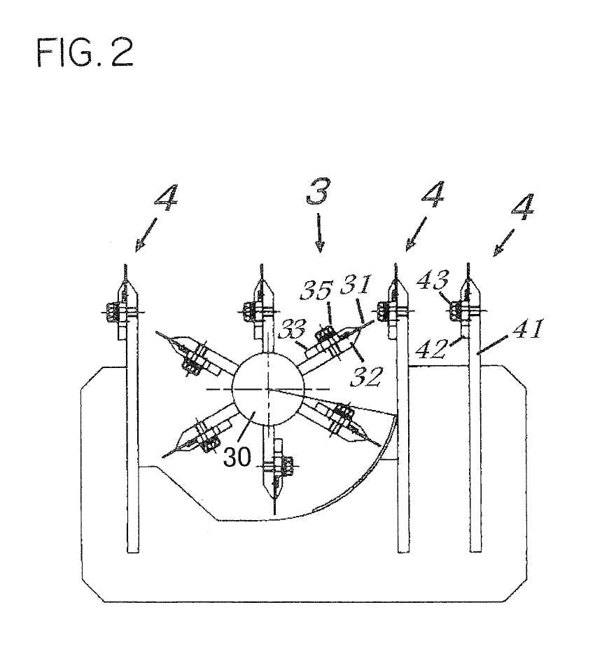

### DETAILED DESCRIPTION OF PREFERRED EMBODIMENTS

A cleaning apparatus and a cleaning method of one embodiment of the present invention will be explained with reference to the drawings.

The reference alphabet A represents a cleaning apparatus removing foreign materials such as a paper powder, a pitch, and the like attached onto a belt-shaped member such as a canvas and the like used for a dryer part of a paper making machine; the reference numeral 1 represents a mesh-like belt-shaped member such as a canvas for papermaking, a felt, and the like; and the reference numeral 2 represents a roller.

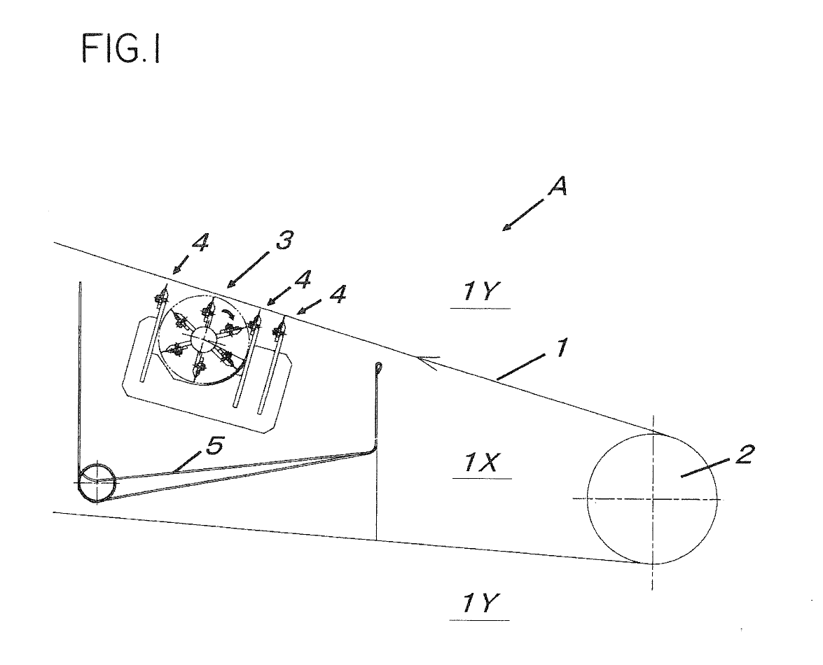

An arrow on the belt-shaped member 1 shown in FIG. 1 represents a movement direction (in FIG. 1, from right to left) of the belt-shaped member 1.

The reference numeral 3 represents a rotary member disposed outside the belt-shaped member 1, and the rotary member 3 rotates opposite to the movement direction of the belt-shaped member 1 (in FIG. 1, the rotation opposite to the movement direction of the belt-shaped member 1 means that the rotary member 3 rotates in a clockwise direction), and scrapes off the foreign materials such as the paper powder, the pitch, and the like on the belt-shaped member 1 by rotary blades 31.

Incidentally, the rotary member 3 is disposed “outside” the belt-shaped member 1. Here, the “outside” means a portion which is not surrounded by the endless belt-shaped member 1, and a portion surrounded by the endless belt-shaped member 1 means an “inside”. FIG. 1 shows one portion of the belt-shaped member 1, and a whole endless belt-shaped member 1 is not shown in the drawing. The reference sign 1X in FIG. 1 represents the “outside”, and the reference signs lY in FIG. 1 represent the “inside”, respectively.

The rotary member 3 includes a shaft 30 rotated by a motor (not shown), a plurality of rotary blades 31 extending radially outwardly from the shaft 30, and the rotary blades 31 are sandwiched by first rotary-blade sandwiching members 32 and second rotary-blade sandwiching members 33 to be fixed by bolts 35.

Incidentally, the rotary member 3 rotates opposite to the movement direction of the belt-shaped member, and in FIG. 1, the rotary member 3 rotates clockwise, and a rotational speed thereof is approximately determined relative to the movement direction of the belt-shaped member. Also, although it is not shown in the drawings, the rotary blades 31 are provided across the entire width of the belt-shaped member 1.

Therefore, according to the aforementioned cleaning apparatus (the cleaning method) A, there is provided the rotary member 3 disposed outside the belt-shaped member 1, and rotating opposite to the movement direction of the belt-shaped member 1 so as to scrape off the foreign materials (the foreign materials are, for example, the paper powder, the pitch, and the like) on the belt-shaped member 1 by the rotary blades 31, so that the foreign materials on the belt-shaped member 1 can be powerfully scraped off to the extent that a rotational direction of the rotary member 3 rotates opposite to the movement direction of the belt-shaped member 1 (for example, the foreign materials (the foreign materials are, for example, the paper powder, the pitch, and the like) entered inside meshes of the mesh-like belt-shaped member 1, can be sucked to be scraped off).

The reference numeral 4 represents a stationary blade disposed outside the belt-shaped member 1, and he stationary blades are provided in front of and behind the rotary member 3 relative to the movement direction of the belt-shaped member 1, and the stationary blades 4 scrape off the foreign materials such as the paper powder, the pitch, and the like on the belt-shaped member 1.

The stationary blades 4 are sandwiched by first stationary-blade sandwiching members 41 and second stationary-blade sandwiching members 42 to be fixed by bolts 43.

Incidentally, as for the stationary blades 4, the foreign materials such as the paper powder, the pitch, and the like on the belt-shaped member 1, which cannot be removed by the rotary blades 31 of the rotary member 3, can be removed by the stationary blades 4 disposed outside the belt-shaped member 1, and provided in front of and behind the rotary member 3 relative to the movement direction of the belt-shaped member 1.

Also, although it is not shown in the drawings, the stationary blades 4 are provided across the entire width of the belt-shaped member 1 as with the rotary blades 31.

Also, the foreign materials scraped off by the rotary blades 31 and the stationary blades 4 are collected by a saucer 5 disposed below the rotary member 3 and the stationary blades 4.

Incidentally, in the present embodiment, the stationary blades 4 are provided in front of and behind the rotary member 3; however, the present invention is not limited to that, and the stationary blades 4 may be provided in front of or behind the rotary member 3.

The disclosure of Japanese Patent Application No. 2014-144091, filed on Jul. 14, 2014, is incorporated in the application.

While the invention has been explained with reference to the specific embodiments of the invention, the explanation is illustrative and the invention is limited only by the appended claims.

What is claimed is:

1. A cleaning apparatus for a belt-shaped member for papermaking, comprising:
a rotary member situated adjacent to the belt-shaped member, and having a plurality of rotary blades rotating in a direction opposite to a movement direction of the belt-shaped member, the rotary member being arranged such that the plurality of rotary blades contacts one side of the belt-shaped member in order, to scrape off foreign materials on the belt-shaped member.

2. A cleaning apparatus according to claim 1, further comprising:
at least one stationary blade provided in front of and/or behind the rotary member relative to the movement direction of the belt-shaped member so that the foreign materials on the belt-shaped member are scraped off by the stationary blade.

3. A cleaning apparatus according to claim 1, further comprising:
a front stationary blade and a rear stationary blade arranged to sandwich the rotary member relative to the movement direction of the belt-shaped member, the plurality of rotary blades being arranged to sequentially contact the belt-shaped member between the front and rear stationary members so that the foreign materials on the belt-shaped member are scraped off by the front and rear stationary blades and the rotary blades.

4. A cleaning method for cleaning foreign materials on a belt-shaped member for papermaking, comprising:
scraping off the foreign materials on the belt-shaped member by rotary blades of a rotary member disposed outside the belt-shaped member and contacting the belt-shaped member, the rotary member rotating in a direction opposite to a movement direction of the belt-shaped member.

5. A cleaning method according to claim 4, wherein the foreign materials on a belt-shaped member are scraped off by at least one stationary blade provided in front of and/or behind the rotary member relative to a movement direction of the belt-shaped member so that the foreign materials on the belt-shaped member are scraped off by the stationary blade.
